(19) United States
(12) Patent Application Publication
(10) Pub. No.: US 2007/0192246 A1
(43) Pub. Date: Aug. 16, 2007

(54) System and method for redirecting internet traffic

(75) Inventor: Michael Dennis Futamase, San Jose, CA (US)

Correspondence Address: OSTROLENK FABER GERB & SOFFEN, 1180 AVENUE OF THE AMERICAS, NEW YORK, NY, 100368403, US

(73) Assignee: InterSearch Group, Inc.

(21) Appl. No.: 11/656,743

(22) Filed: Jan. 22, 2007

Related U.S. Application Data
(60) Provisional application No. 60/761,094, filed on Jan. 23, 2006.

(51) Int. Cl. G06Q 40/00

(52) U.S. Cl. 705/40

(57) ABSTRACT

Disclosed is a system and method for receiving payment by brokering web site traffic. A first domain is registered, and an offer of payment is received from a party in exchange for receiving redirected internet traffic. The traffic requested a resource associated with the first domain and is redirected to a resource that may be associated with a second domain. The offer is accepted from the party for the redirected internet traffic. Further, a request is received for a connection to the resource associated with the first domain, and the traffic is redirected to the second resource associated with the second domain in exchange for the payment.

### CROSS-REFERENCE TO RELATED APPLICATION

This application is based on and claims priority to U.S. Provisional Patent Application Ser. No. 60/761,094, filed on Jan. 23, 2006 and entitled SYSTEM AND METHOD FOR REDIRECTING INTERNET TRAFFIC, the entire contents of which is hereby incorporated by reference herein.

### BACKGROUND OF THE INVENTION

1. Field of the Invention

The present invention relates generally to networking and, more particularly, to URL redirection processes.

2. Description of the Related Art

Many users of the Internet operate web browser software applications (hereinafter, referred generally to “web browsers”) which enable users to access an internet web site or other resource via the known hypertext transport protocol (“HTTP”) in a variety of ways. For example, a user may enter a uniform resource locator (“URL”) or, alternatively, a uniform resource identifier (“URI”) in a text box in the web browser, referred to generally as an “address bar,” and the browser uses the URL to request a communication session with the web site represented thereby. In another example, internet web sites contain links to other web sites, known in the art as “hyperlinks,” which users select via a mouse or other pointing device to request a communication session with the web site represented by the hyperlink. Other internet related services are available via web browsers, including file transfer services, e-mail services and the like.

A common experience shared by internet users is the entry of a keyword or URL that is relatively generic, such as “www.money.com.” In such case, the domain name, “money.com” may be registered to a party and the user is connected to the web site associated therewith. Often, the user's web browser is redirected to a web site which has a different domain name. For example, the user who submits www.money.com is redirected to the web page money.cnn.com, which is related to the CNN domain.

Another common experience shared by many internet users is the reception of a web site or message that was unintended and/or unexpected. For example, a user makes a typographical mistake in the web browser address bar and enters a URL that does not represent an active web page. In such case, an HTTP error code may be generated, such as the known “HTTP 404 Page Not Found” error, and the web server to which the user connected may transmit a simple a message that the requested page cannot be displayed. In one example and in case a user is operating the MICROSOFT INTERNET EXPLORER web browser, a “default” HTTP 404 Page Not Found error screen is displayed to the user when the requested web page does not exist and the error message transmitted from the web server is fewer than 512 characters in length. An example of a typical HTTP 404 Page Not Found error display screen 10 that appears in MICROSOFT INTERNET EXPLORER is shown in FIG. 1.

Alternatively, a customized error display screen can be formatted and/or transmitted by the web server and, in case the web server transmits a customized HTTP 404 Page Not Found error display screen that exceeds 512 characters, the user's browser displays the customized display screen.

Other HTTP error codes may be transmitted to a web browser, such as HTTP 400 Bad Request, HTTP 401 Unauthorized or HTTP 403 Forbidden. Use of customized error message display screens in response to such errors that are transmitted by web servers is becoming increasingly popular.

HTTP errors, such as 404 Page Not Found errors, happen for many reasons. One common reason for a page not found error is due to a revised directory structure on a web server. This typically results because a file that existed at one location is no longer stored there. For example, an article on dogs that was published on the CNN web site as www.cnn.com/article43/dogs.html is eventually archived and moved to www.cnn.com/archives43/dogs.html. A user who enters the original URL, for example by using his web browser address bar, referencing his stored web browser cache, selecting a search engine hyperlink or the like will not be able to locate the article.

One method of handling an HTTP 404 Page Not Found error is by implementing a process known in the art as redirection. A URL redirection typically results from instructions being executed on a web server, i.e., a computer system configured to operate as an HTTP server, and to display web pages in response to HTTP error, for example, from web browsers. A typical redirection involves a web server instructing a user's web browser to access a web page at an internet address other than the address originally requested by the browser.

It is known in the prior art to invoke an automatic redirection process in case an HTTP 404 Page Not Found error occurs. Often implemented by a relatively simple set of commands in a script, an automatic redirection program is configured to redirect web browsers that receive 404 Page Not Found errors that are caused by a number of conditions. For example, misspelling of a web site in a web browser software application's address bar or a hyperlink that points to a web site or a web page that does not exist. In some contexts, in case the script is unsuccessful in redirecting the web browser software application to a web site, alternative file names can be searched for possible redirection. Other features can be implemented in a redirecting script or other program, such as alerting a proprietor of a web site by e-mail or other form that a broken link exists or that a user of standard web browsing application software attempted to access a web page that does not exist.

In another example, the web browser application may be programmed to redirect a user's session to a particular web page and/or to provide some functionality. For example, the INTERNET EXPLORER web browser that is shipped with a DELL personal computer may be programmed to recognize when an HTTP error is received, and to subsequently and automatically enter a new URL into the address bar, effectively redirecting the user's session to another web site.

For example, a user operating the INTERNET EXPLORER browser installed on a DELL personal computer enters the URL, www.irs.gob (instead of www.irs.gov), in his web browser's address bar. The user expects to access the official web site of the Internal Revenue Service as provided by the United States government. Unfortunately, the correct URL for the Internal Revenue Service is www.irs.gov, and so the user does not access the correct web site. In the present example, the domain irs.gob, is not registered to (i.e., owned by) any party, and, therefore, no web site is available at the URL the user entered. Accordingly, the user receives an HTTP error, such as 400 Bad Request. The DELL computers that provide INTERNET EXPLORER web browser automatically save and apply the incorrectly entered URL by submitting the http://www.google.com/hws/dell/afe?hl=en&s=http://www.irs.gob/URL in the web browser address bar. The user, consequently, is redirected to the GOOGLE search engine, particularly to a respective directory dedicated to DELL, and a search is automatically performed using the incorrectly entered URL (www.irs.gob) as the keyword. In this particular example, DELL, INC. receives a benefit because GOOGLE provides hyperlinks to the DELL home page and related web sites. Users may select those hyperlinks and purchase computers and/or other devices/services from the DELL, Inc. web site.

The above example of redirecting a mistyped internet web site to GOOGLE is illustrated in display screen 12, shown in FIG. 2.

HTTP errors, such as the 404 Page Not Found error, can be triggered in other ways, as well. For example, the error can occur when a user operating a web browser selects a hyperlink in a web site that points to a link that does not exist. For example, a user operating a standard web browser software application accesses a web site directed to athletic gear. The athletic gear web site includes a hyperlink in the form of a graphical icon that states “click here for sneakers.” The user selects the icon and receives an HTTP 404 Page Not Found error. In the present example, the error occurred because the proprietor of the sneakers web site terminated (or “brought down”) the web site and never alerted the proprietor of the athletic gear web site. In one context, programming code, for example, in the form of scripts, performs error checking processes in order to inform proprietors of hyperlinks in their web sites that point to web sites that do not exist (so called “broken links”).

Continuing with reference to the drawings, in which like reference numerals refer to like elements, there is shown in FIG. 3 an example of a typical prior art hardware arrangement of computing devices that communicate via the hypertext transport protocol over a communication network, such as the internet, and referred to herein, generally, as system 100.

In the typical environment shown in FIG. 3, internet service provider 102 provides bandwidth for client devices 104 to access communication network 105 (e.g., the internet). Domain Name System (“DNS”) servers 106 run DNS services to translate alphanumeric host name requests from clients 104 into numeric internet addresses. Web servers 108 provides web site content to requesting clients 104. Also shown in FIG. 3, routers 110 are included to provide access to various network resources, and/or to operate as a gateway. Routers 110, as known in the art, are programmable, and can also operate to determine an optimal path along which network traffic should be forwarded. Routers 110 forward packets from one network to another in response to network layer information.

Although the example system 100 shown in FIG. 3 identifies various information processors as separately operable devices, one skilled in the art will recognize that a single information processor, or combinations of information processors, may be sufficient for the various services provided by the devices shown in FIG. 3. For example, an internet service provider 102 may also operate as a DNS server 106, web server 108, router 110 and client 104. Further, network 105 can be any communication network, and preferably is a global communication network such as the Internet.

FIG. 4 illustrates the prior art arrangements of devices of system 100 and includes private network 107 that is “behind” security system 109. Private network 107 may be configured in a variety of ways, including as a local area network (“LAN”), a wide area network (“WAN”) or another known configuration. Security system 109 protects hardware devices provided on network 107 from potential on-line attacks from an outside source, such as a malicious hacker. Typically, security system 109 includes, for example, proxy server 112 and firewall 114. Of course, one skilled in the art will recognize that company security system 109 can be configured in a variety of ways, and may include fewer or more hardware devices. For example, proxy server 112 and firewall 114 may be incorporated in a single hardware device. Alternatively, proxy server 112 and firewall 114 may include other physically separate devices that include, for example, a router 110, personal computers, a dedicated firewall, and/or some other computer-related hardware.

In accordance with the teachings herein, the term, “proxy server” 112 is provided for descriptive purposes, and not intended to limit device 112 to function solely as a proxy server, as known to those skilled in the art. For example, device 112 may function as a web server, a file server or some other device capable of providing information content. Therefore, as used herein, proxy server 112, generally, represents a server or other device that is provided between a client application, such as a web browser software application operating on a private network, and a server that is available on a publicly accessible network. Preferably, proxy server 112 attempts to fulfill requests from client applications. Proxy server 112 is further preferably configured to forward requests from client applications to another device, for example, web server 108.

Also as used herein, the term client device 104 refers, generally, to any computing device operating an internet web browser software application, such as MICROSOFT INTERNET EXPLORER or MOZILLA FIREFOX. More generally, client devices 104 may refer to any device operable to communicate over a communication network and to request communication sessions with other devices.

It is recognized by the inventor that users of web browser software applications that receive HTTP 404 Page Not Found errors are frustrated because the information they expect to receive does not appear. Furthermore, some (possibly many) of these users do not know additional steps to take to locate the content they are seeking. Experienced users typically need to investigate alternative measures for locating the content they seek, such as via a search engine. In the former case, users may simply close their web browser software applications, or may access a totally unrelated web site. In either case, however, it is believed by the inventor that users that receive HTTP 404 Page Not Found errors experience a level of frustration.

In view of the frustration experienced by users who receive HTTP 404 Page Not Found errors, the inventor believes that an opportunity to capitalize on a likelihood that such users are receptive to suggested web sites. For example, in case an automatic redirection is implemented for a particular HTTP 404 Page Not Found error, the user may be willing to spend time reviewing a web site that automatically appears. Continuing with the above example regarding athletic gear, in the event that the link to the sneakers web site is broken (i.e., points to a web page that doesn't exist), a redirect process may automatically display a web page directed to a magazine that reviews sneakers. Thus, even though the visitor was expecting a web site to view and/or purchase sneakers, the visitor may be willing to spend some time reviewing the magazine's web site, and may purchase a subscription to the magazine as a result. This general concept may apply in virtually unlimited contexts, whereby a users who enters an incorrect URL in an address bar or selects an icon in a web page that contains broken links may be receptive to web pages that are displayed automatically as a result of a redirect process. Another context may be when a user enters a simple keyword or generic URL that is owned by one party and the user's web browser software application is redirected to a different web site, for example, associated with a different domain.

### SUMMARY OF THE INVENTION

Accordingly, the present invention includes a system and method for receiving payment by brokering web site traffic. A first domain is registered, and an offer of payment is received from a party in exchange for receiving redirected internet traffic. The traffic requested a resource associated with the first domain and is redirected to a resource that may be associated with a second domain. The offer is accepted from the party for the redirected internet traffic. Further, a request is received for a connection to the resource associated with the first domain, and the traffic is redirected to the second resource associated with the second domain in exchange for the payment.

Alternatively, the invention comprises a system for redirecting an internet web browser that comprises a first module operable to determine an hypertext transport protocol error received in connection with a request from the web browser to access a first resource. A second module is operable to determine an identification of the web browser making the request. A third module is operable to receive a plurality of bids for receiving the redirected web browser, wherein each of the bids is stored on an information processor. Further, a fourth module is provided that is operable to receive from the information processor information representing a highest of the plurality of bids and to determine a web site associated with the highest bid. Moreover, a fifth module is provide that is operable to redirect the web browser to the web site associated with the highest bid.

Other features and advantages of the present invention will become apparent from the following description of the invention, which refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example HTTP 404 Page Not Found error display screen;

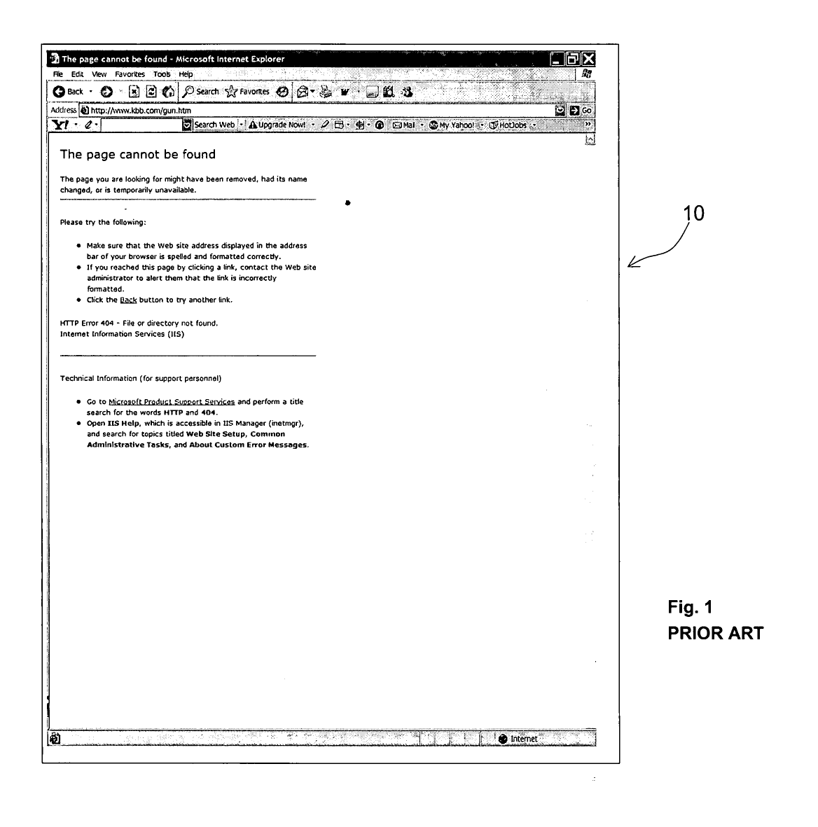

FIG. 2 is a example display screen representing a redirected and mistyped internet web site request;

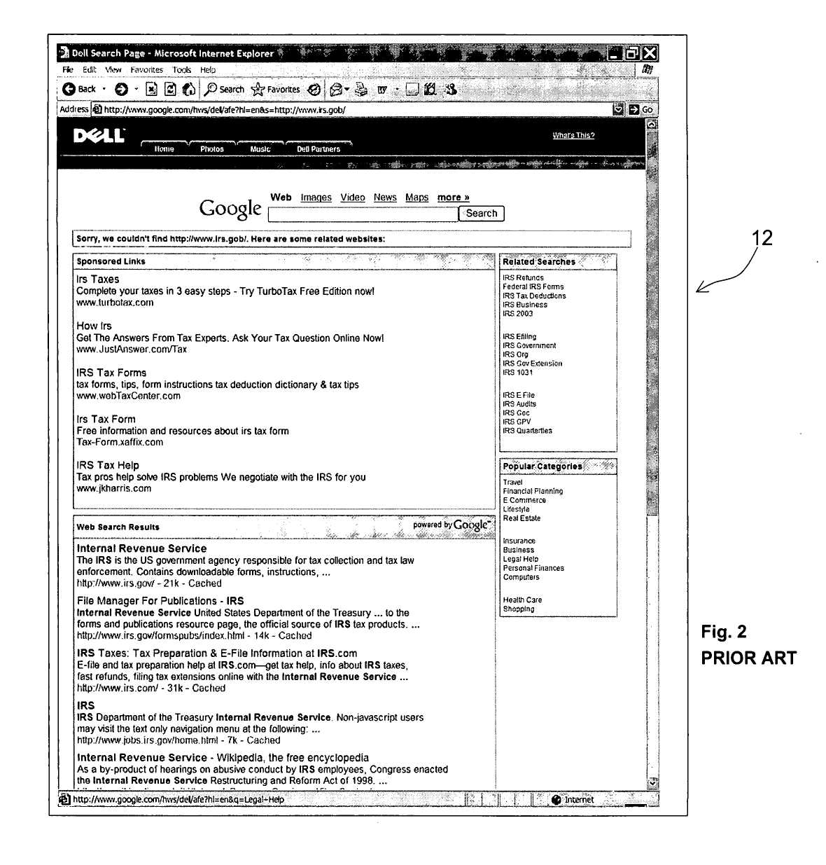

FIG. 3 illustrates an example of a prior art hardware arrangement of computing devices that communicate via the hypertext transport protocol;

FIG. 4 illustrates the prior art arrangement shown in FIG. 3 and includes a private network;

FIG. 5 shows an arrangement of hardware devices provided in accordance with a preferred embodiment of the present invention;

FIG. 6 illustrates functional elements of an information processor in accordance with the present invention;

FIG. 7A illustrates an example arrangement and operation of a plurality of devices that are preferably operated by parties in accordance with a preferred embodiment of the present invention;

FIG. 7B illustrates an example arrangement and operation of a plurality of devices that are preferably operated by parties in accordance with an alternative embodiment of the present invention;

FIG. 8 is an example flow chart that includes steps associated with an embodiment of the present invention; and

FIG. 9 is a flow chart that represents steps associated with redirecting web traffic in accordance with an alternative embodiment of the present invention.

### DESCRIPTION OF THE PREFERRED EMBODIMENTS

A system and method is provided that redirects internet traffic of at least one client device 104 in which a request for a connection to a web site associated with a first domain is submitted by the client device 104, and the client device 104 is redirected to a web site that is represented by a second URL that may be associated with a second domain. The second domain may be owned by a different party than the party that owns the first domain. Preferably, the party owning the web site represented by the second URL submits a competing bid to a proprietor of the present invention in order to receive the redirected internet traffic. For example, a user operating client device 104 submits the URL, www.money.com. In this example, the domain, money.com, is registered to the proprietor of the present invention, and the proprietor has received bids from various financial service providers for traffic from client devices 104 that attempt to connect to the URL, www.money.com. Accordingly, the proprietor of the present invention redirects the client device 104 to a web site owned and/or operated by the highest bidder.

In an alternative embodiment, the proprietor of the present invention receives bids from owners of web sites for redirected traffic resulting from requests for connections to a plurality of respective domains. For example, a financial service provider bids to receive redirected internet traffic for any connection requests to the domains, www.money.com, www.cash.com, www.finance.com, and the like.

Thus, in accordance with one embodiment, a proprietor of the present invention registers a domain that the proprietor expects will receive web-related traffic, such money.com. When users enter www.money.com in their web browsers' address bars, the proprietor invokes a URL redirection process. The proprietor, accordingly, accepts bids from competing owners of various internet web sites who desire to have redirection processes point the users' web browsers to the owners' respective sites. In one embodiment, the highest bidder receives the redirection traffic.

Examples of bidding practice, particularly with respect to internet-related applications, are known. For example, U.S. patent application Ser. No. 11/157,418 and assigned to the assignee of the present patent application describes a bidding practice, the entire contents of which are incorporated by reference as if set forth completely herein.

In an alternative embodiment, the present invention is directed to a system and process that capitalizes on the benefits resulting from a user of client device 104 who encounters one or more HTTP errors, such as the HTTP 404 Page Not Found error. In this embodiment, bids from are similarly received from parties desiring to receive internet traffic that is redirected. Unlike the previous embodiment, however, proprietors of web sites desire to receive web site traffic from web browsers that received HTTP errors, such as HTTP Page Not Found.

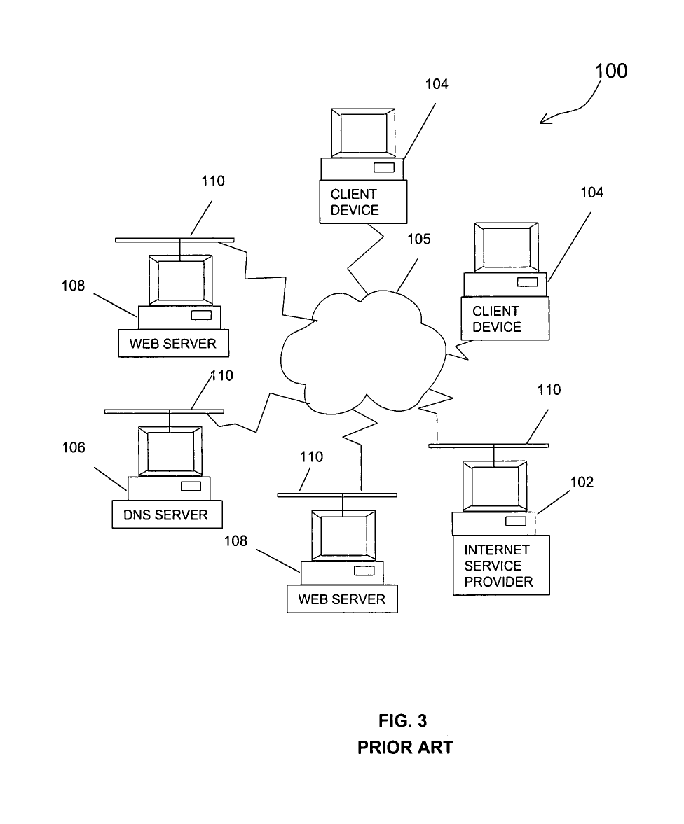

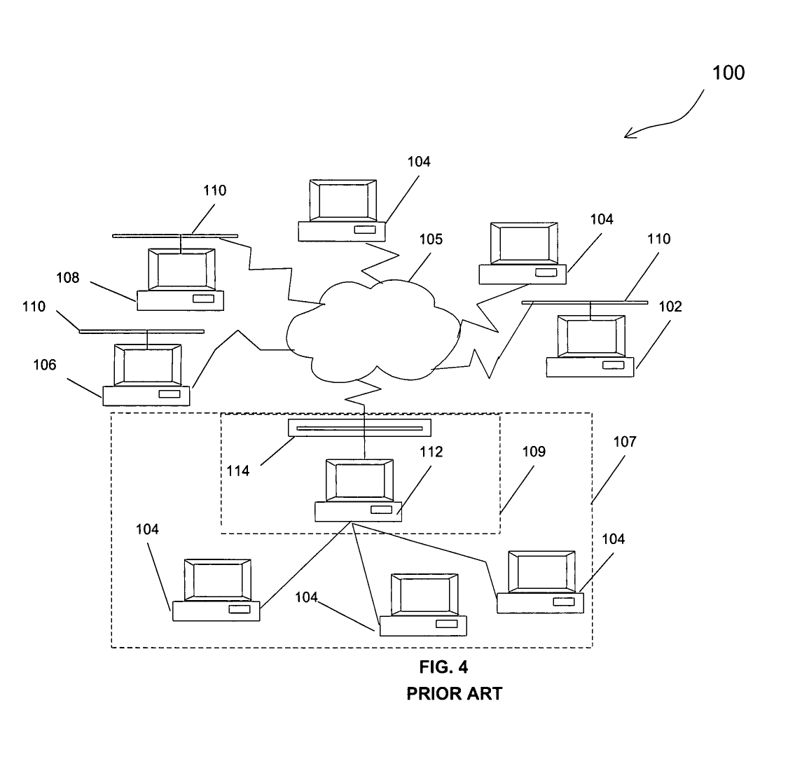

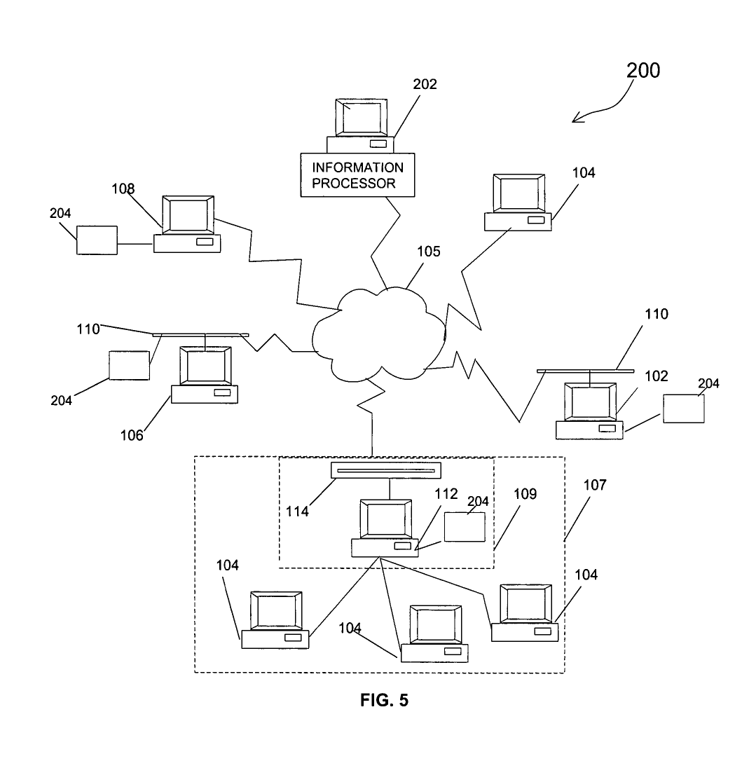

Referring now to FIG. 5, an arrangement of hardware devices provided in accordance with an embodiment of the present invention is shown and referred to herein, generally, as URL redirection system 200. In addition to the devices shown in FIGS. 3 and 4, information processor 202 is included in URL redirection system 200 and preferably operated under the control of a proprietor of the present invention. Processor 202, for example, provides interfaces and applications enabling proprietors of competing web sites to receive internet traffic redirected thereto. Further, processor 202 preferably provides application 204 enabling one or more of the internet service provider 102, DNS server 106, web server 108 and/or router 110 to each independently provide URL redirection. As known in the art, application 204 may be configured as software, hardware or a combination thereof.

Whenever a person using a web browser (or other communications software) on client device 104 submits a request for an internet web site communication session, data packets are generated and transmitted to a respective internet service provider, and routed through the internet via devices such as illustrated in FIG. 5. For example, data packets are received and forwarded by one or more internet service providers 102, DNS servers 106, web servers 108 and/or routers 10. Further, various load balancing and other resource allocation measures may be implemented which further distribute data packets over the internet 105. Any of the devices associated with data packet forwarding, including relating to sending and receiving requests for web sites and/or HTTP error messages, are preferably operable to recognize certain information provided in the data packets. For example, the internet protocol (“IP”) address of the requesting client 104 can be identified, the respective requested service, a respective returned error message (if any), or the like. By referencing and using data in the packets, the present invention enables URL redirection to one or more of web sites in accordance with one or more embodiments that use information in data packets therefor and described in greater detail below.

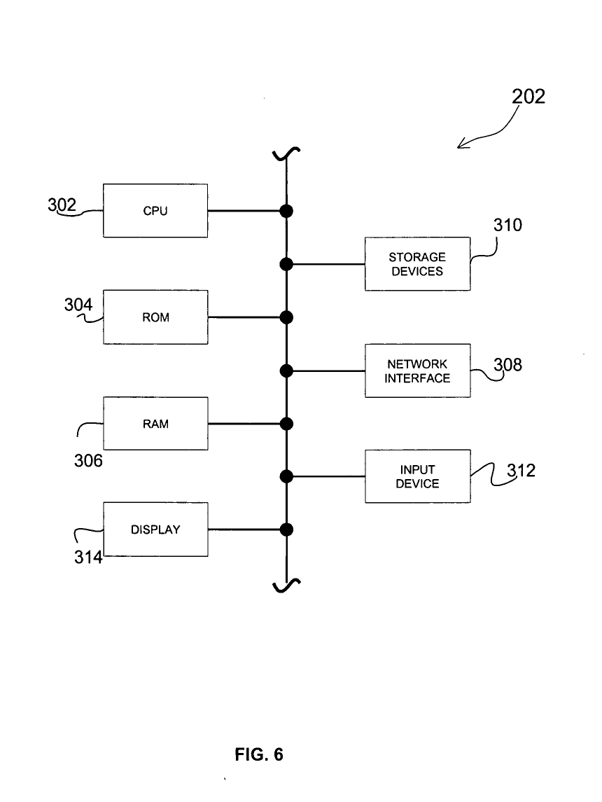

As shown in FIG. 6, the functional elements of information processors, such as information processor 202 include one or more central processing units (CPU) 302 used to execute software code and control the operation of information processor 202, read-only memory (ROM) 304, random access memory (RAM) 306, one or more network interfaces 308 to transmit and receive data to and from other computing devices across a communication network, storage devices 310 such as a hard disk drive, floppy disk drive, tape drive, CD ROM or DVD or storing program code, databases and application data, one or more input devices 312 such as a keyboard, mouse, track ball, microphone and the like, and a display 314.

The various components of information processor 202 need not be physically contained within the same chassis or even located in a single location. For example, storage device 310 may be located at a site which is remote from the remaining elements of information processor 202, and may even be connected to CPU 302 across communication network 105 via network interface 308.

Information processor 202 may be equipped with sufficient storage to provide the necessary databases and other services described herein, as well as acting as a web server for communicating hypertext markup language (HTML), XML, Java applets, Active-X control programs or the like, to client devices 104, web servers 108, or other devices, such as shown in FIG. 5. For example, when a user of client device 104 activates web browser software, he is connected to information processor 202, which functions as an HTTP server and provides HTML content. Preferably, information processor 202 is arranged with components, for example those shown in FIG. 6, suitable for the expected operating environment of information processor 202. The central processing unit(s) 302, network interface(s) 308 and memory and storage devices are selected to ensure that capacities are arranged to accommodate expected demand.

The functional elements shown in FIG. 6 (designated by reference numerals 302-314) for information processor 202 are of the same categories of functional elements also present in client device 104, DNS server 106 and web server 108. However, not all elements need be present in all devices in the same size and configuration. For example, CPU 302 in client device 104 is typically a smaller capacity CPU than the CPU present in the information processor 202. Similarly, it is likely that the information processor 202 will include storage devices of a much higher capacity than storage devices present in client device 104.

Of course, one of ordinary skill in the art will understand that the capabilities of the functional elements can be adjusted as needed. The nature of the invention is such that one skilled in the art of writing computer executable code (software) can implement the described functions using one or more or a combination of a popular computer programming languages including, but not limited to C++, Visual Basic, Java, Active-X, HTML and web application development environments.

Although the present invention is described by way of example herein and in terms of a web-based system using web browsers and a web site server (information processor 202), system 200 is not limited to the above configuration. It is contemplated that system 200 can be arranged such that client devices 104 can communicate with and display data received from other devices using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used, for example, WINDOWS 3.x, WINDOWS 95, WINDOWS 98, WINDOWS NT, WINDOWS MILLENNIUM, WINDOWS 2000, WINDOWS XP, WINDOWS CE, Mac OS, UNIX, LINEX, Palm OS and any suitable PDA or palm computer operating system.

As used herein, references to displaying data on client device 104 refers to the process of communicating data to the terminal across communication network 105 and processing the data such that the data is viewed on displays 314 using a web browser or the like. As is common with web browsing software, the display 314 on client devices 104 present sites within the networked system 200 such that a user can proceed with from site to site within the system by selecting a desired link.

Also as used herein, the term, “module,” refers, generally, to one or more discrete components that contribute to the effectiveness of the present invention. Modules can include software elements, including but not limited to functions, algorithms, classes and the like. Modules also include hardware elements, substantially as described below. Modules can operate independently or, alternatively, depend upon one or other modules in order to function.

Also as used herein, the term, “internet traffic,” refers, generally, to client devices and/or related data associated therewith that request access to a web site.

According to a preferred embodiment, web site proprietors compete to receive internet traffic resulting from, for example, users who request a connection to a web site associated with a particular domain. Preferably, each of a plurality of web site owners submits a bid to the proprietor of the present invention to receive the redirected web site traffic. The bids may be provided for a single redirection occurrence, or from multiple redirection occurrences, for example, over time, depending upon a preferred business deal struck by the various parties. Further, a web site proprietor who wins a bid for redirected web traffic in accordance with the teachings herein may elect to resell or otherwise transfer the rights to such traffic.

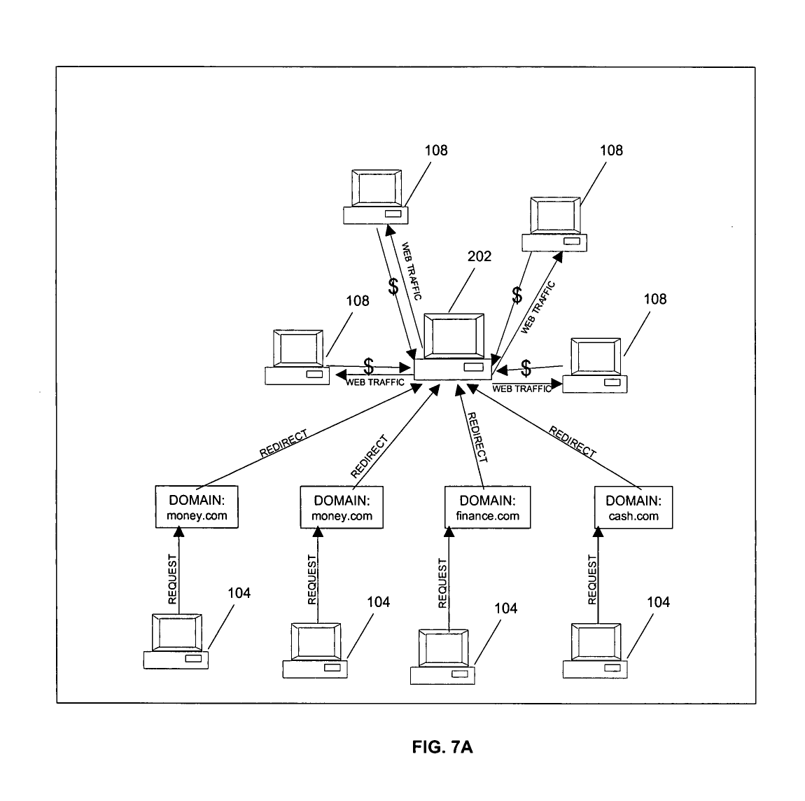

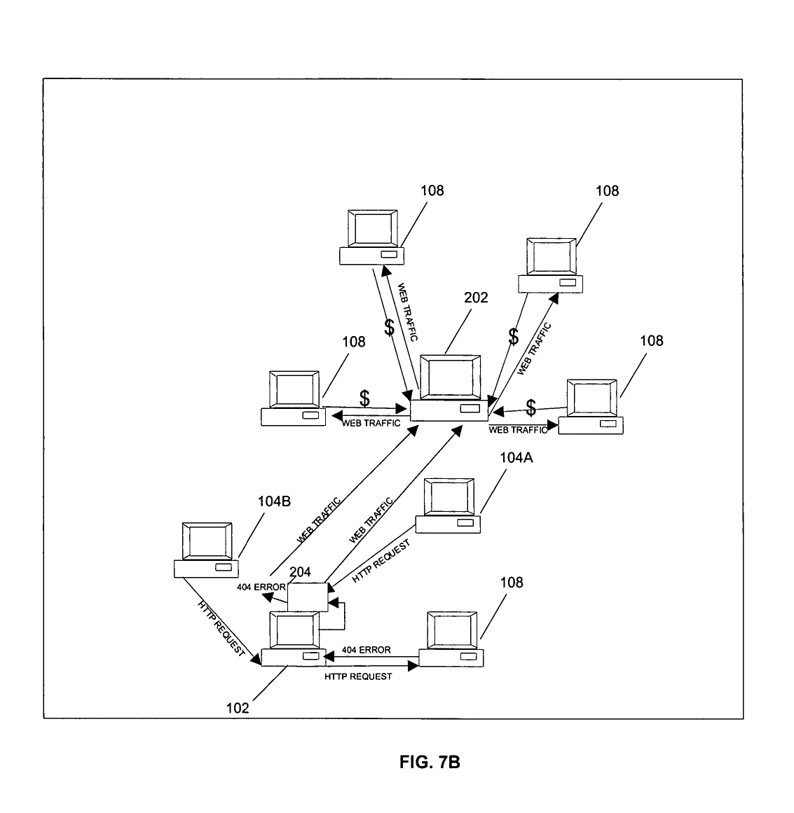

FIG. 7A illustrates an example arrangement and operation of a plurality of devices that are preferably operated by parties in accordance with a preferred embodiment of the present invention. As shown in FIG. 7A, client devices 104 make HTTP connection requests and specify one or more domain names, such as www.money.com, www.finance.com or www.cash.com. The domains may be registered (i.e., owned) by one party, including the proprietor of the present invention, or the domains may be registered to a plurality of parties.

In accordance with a preferred embodiment, once the request from the client device 104 is received, the client 104 web browser (or other application) is preferably redirected to information processor 202. For example and in case one domain, such as “cash.com” is not owned or registered to the proprietor of information processor 202, DNS settings can be adjusted so that the clients 104 attempting to connect to that domain (e.g., cash.com) are automatically connected to information processor 202. Alternatively, a web site can be configured with the respective domain (e.g., cash.com) and any requests are automatically forwarded to information processor 202.

In an alternative embodiment, application 204 operates to redirect HTTP requests from client 104 to a respective web server 108. For example, application 204 may be configured to operate with the web browser software application operating on device 104. Application 204 may communicate with information processor 202 to receive instructions or other information representing the respective web server 108 that will receive redirected traffic. After application 204 receives the respective information from server 202, the web browser in conjunction with application 204 substantially automatically redirects the web browser to the web site associated with the respective web server 108. In this way, information processor 202 does not receive the redirected traffic from the client device 104, and, instead, the web browser operating on device 104 is automatically redirected to the respective web server 108.

Continuing with embodiment illustrated in FIG. 7A, request(s) that are redirected to and received by information processor 202 are forwarded (or redirected) to one or more web servers 108 in exchange for money or other valuable consideration. Preferably, proprietors of a plurality of respective web servers 108 bid for the rights to receive the redirected internet traffic. One skilled in the art will recognize that various business structures can be supported. For example, one web server 108 may bid for the right to receive traffic originating to a plurality of domains (e.g., money.com, cash.com and finance.com). Alternatively, one web server 108 may bid to receive traffic from just one domain. Further, a plurality of web servers 108 may divide the rights to internet traffic, each alternately receiving redirected web traffic resulting from a plurality of client device 104 requests.

In the example embodiment shown in FIG. 7A, the proprietor of information processor 202 receives payment in exchange for redirected internet traffic. In an alternative embodiment, a portion of payment received for the traffic is distributed to one or more registered owners of the respective domains. For example, the owner of cash.com may receive fifteen percent (15%) of all revenue generated to the proprietor of information processor 202 resulting from redirected traffic. Thus, the proprietor of information processor 202 can also function as a sort of broker for owners of domain names.

The invention is now further described with reference to an alternative embodiment illustrated in FIG. 7B.

FIG. 7B illustrates an alternative embodiment wherein HTTP requests from client device 104 receive errors, such as 404 Page Not Found errors, and the web browser operating on device 104 is redirected to information processor 202 for eventually redirection to a respective web server 108.

As noted above, there are various ways in which a user receives an error, such as an HTTP 404 Page Not Found error. For example, a user may simply mistype a web host address into his web browser address bar. Alternatively, a user may select a URL using a drop down list from the user's web browser address bar. The URL may represent a web page that was posted on a web server at a first location, but later relocated to a second location. In yet another alternative example, the user may select a URL from the user's web browser's cached history of previously visited web sites, and the web page previously represented by the URL no longer exists or has been moved. In still another alternative example, the user may select a broken hyperlink from a web page, such as generated by a search engine or provided by a web site. Thus, users of internet web browser software applications receive various kinds of HTTP errors, such as caused by these and other ways known to one skilled in the art.

Typically, the various devices that are involved in examining and forwarding data packets over the internet can become aware of the respective HTTP error, such as 400 Bad Request, that a user receives. In one embodiment, when one of the respective devices recognizes that an HTTP error has occurred, that device preferably examines the packet(s) to determine the IP address of the user that received the HTTP error and redirects the user to a new destination.

FIG. 7B illustrates an example arrangement and operation of a plurality of devices that are preferably operated by parties to the present invention. As shown in FIG. 7B, proprietor of information processor 202 receives and/or controls web site traffic originating from web client 104 that is redirected one or more of the plurality of proprietors of web servers 108. As shown in the example embodiment, client 104A connects to proprietor 202 via an HTTP request. For example, client 104A was seeking to connect to www.irs.gov and, instead, entered www.irs.gob in his web browser address bar. Internet service provider 102 receives the request from client 104A, and forwards the request to proprietor 202. Once the connection to proprietor 202 is made, then and in exchange for capital or valuable consideration, web traffic is redirected to web server(s) 108.

Alternatively and also illustrated in FIG. 7B, client 104B enters a request for a web page that does not exist at the location specified in the URL. The request is received by internet service provider 102 and forwarded to server 108. Web server 108 is unable to locate the respective web page and transmits a 404 Page Not Found error to internet service provider 102. Internet service provider, operating application 204, intercepts the 404 error, and analyzes the request and requesting client 204B (e.g., the IP address of client 204B) to determine whether the client 204B traffic should be redirected to proprietor 202. After determining that client 204B should be redirected, internet service provider 102 redirects the traffic to proprietor 202. Proprietor 202, accordingly, forwards the traffic to an appropriate server 108 in exchange for capital or other valuable consideration. One skilled in the art will recognize that the embodiment illustrated in FIG. 7B represents an example, and that other conditions and arrangements are envisioned herein, such as other kinds of HTTP errors and the inclusion of various other devices, such as proxy servers 112, DNS servers 106, firewalls 114 and routers 110, all of which are operable to be programmed to perform some or all of the features described herein.

Alternatively, and as described above with reference to FIG. 7A, information processor 202 does not receive redirected Internet web traffic directly. Instead, application 204 operating on at least one of the plurality of devices shown in FIG. 5 operates to redirect traffic to a respective web server 108 directly.

In one embodiment, web site proprietors compete to receive redirected internet traffic in accordance with the teachings herein that represents a particular category. For example, a proprietor of a web site that sells shoes would probably not be interested in web site traffic representing users who are looking for televisions. The proprietor of the web site directed to shoes would be more likely to be inclined to bid for web site traffic of users who are looking for goods and/or services that closely represent those sold his web site.

Accordingly, the present invention provides ways in which a party who bids for redirected web traffic receives traffic that is appropriate. In one embodiment, a party, who may be a proprietor of the present invention, preemptively registers a domain, such as www.money.com. The party believes in advance that various users will enter the www.money.com URL, and those who do will be connected to the party's web site located at that address. Once the user connects to the party's web site (e.g., www.money.com), the owner of the web site preferably redirects the user's web browser to one of a plurality of web sites, for example, related to financial services and/or investment advice, whose proprietors have bid for and/or paid for the respective traffic. In this embodiment, an analysis to determine a user's intent of a desired web site or category of web site is unnecessary. Instead, the intent of any user who connects to the party's web site is presumed, and the traffic is appropriately redirected.

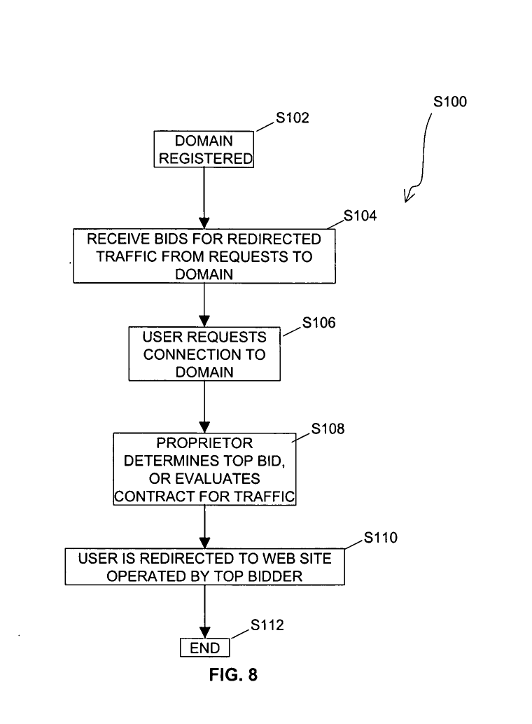

FIG. 8 is an example flow chart that includes steps S100 associated with an embodiment of the present invention. Although the steps shown in FIG. 8 are shown in a particular sequence, the invention is not so limited. One skilled in the art will recognize that the steps may occur in other sequences, and that various individual steps may represent a plurality of steps. At step S102, a party, who may be a proprietor of the present invention, registers a domain that the party expects to receive traffic. Thereafter, the proprietor of information processor 202 receives bids for redirected traffic resulting from requests to connect with a web site at the respective domain (step S104). At step S106, a user requests for a connection to a web site associated with the domain. The proprietor evaluates the bids and determines a top bid received, and or evaluates other contractual agreements for the traffic (step S108). The user is redirected, accordingly (step S110), and at step S112, the process ends.

In an alternative embodiment, techniques are provided for determining the web site or the category of web site that a user who receives an HTTP error had intended to access. For example, a user may mistype a URL in the user's web browser address bar and the intended web site name and/or category can be readily determined. For example, a user who incorrectly enters the URL www.irs.gob (instead of irs.com), the present invention recognizes the “irs” portion of the incorrectly accessed URL and determines, for example, by referencing a lookup table or other known database object, the user intended to visit the web site hosted by the Internal Revenue Service. Alternatively, in case the user selects a broken link, for example provided by a search engine or other web site, or in case the user selects a cached URL that no longer points to a respective web page, the URL may be examined for clues as to the particular site/category of site that the user was intending to visit.

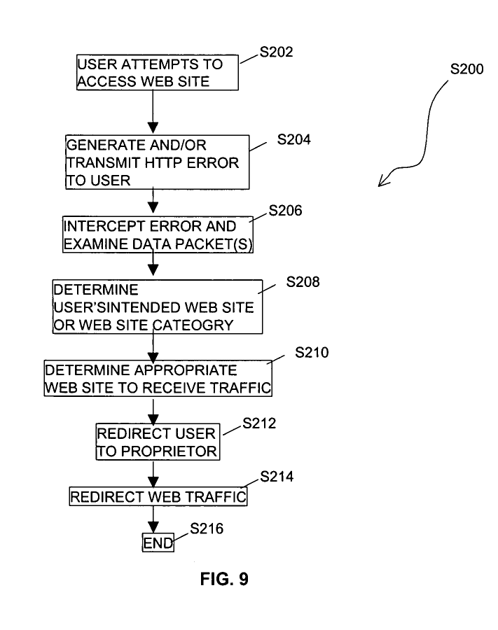

FIG. 9 is a flow chart that represents steps S200 associated with redirecting web traffic in accordance with the alternative embodiment described above. At step S202, the user attempts to access a web site, for example by typing directly a URL in his web browser address bar or by selecting a hyperlink provided in another web site. The web page identified by the URL of the site does not exist, and, accordingly an HTTP error is generated and/or transmitted to the user (step S204). The user, however, does not receive the error as the error is intercepted, for example by internet service provider 102, DNS server 106 and/or router 110, and the data packet(s) are examined, for example by application 204 (step S206). The user's intended web site, or category of web site, is then determined, for example, as a function of the data packet(s) (step S208). The user's browser is then redirected, for example to proprietor 202 (step S210). In one embodiment, information is provided to proprietor's information processor 202 that identifies or otherwise represents the web site or category thereof that the user intended to access. The proprietor's information processor 202 uses that information to determine the appropriate web site to receive the traffic (step S212). For example, information processor 202 evaluates bids associated for redirected web site traffic for a particular category of web sites, and identifies the highest bidder thereof. At step S214, the web traffic is redirected, and at step S216, the process ends.

In accordance with preferred embodiments described herein, there are various ways for ensuring that web site traffic is redirected to one or more of a plurality of web sites. In one embodiment, as described above, a party registers a domain that he expects will receive traffic, and when traffic to the site is received, the traffic is redirected to one or more bidders for the respective traffic.

As noted above, in an alternative embodiment, the user's web browser includes programming code, such as application 204 that is operable to recognize when an HTTP error is received, and to redirect the web browser to proprietor 202 or to a web server 108, in accordance with the teachings herein.

In yet other embodiments, one or more of the internet service provider 102, domain name service server 106, router 110, or proxy server 112 recognize when an HTTP error is transmitted to a requesting user, and the respective device(s) inspect relevant data packet(s) to determine the requesting browser's IP address, and the respective web site or web site category that the user intended to access. Thereafter, the respective device 102, 106, 110 and/or 110 redirects the user's browser, for example, via proprietor 202 or to web site 108, in accordance with the teachings herein.

Thus, as will be evident to one skilled in the art, the present invention can be implemented in numerous ways without departing from the teachings herein. The invention is now described with reference to an example.

A user operating web client 104 and desiring to access the official web site of the San Diego Zoo enters www.sandiegozoo.edu in his web address bar. The actual web address of the San Diego Zoo is www.sandiegozoo.org. In this example, the URL www.sandiegozoo.edu is not registered and, in the prior art, an attempt to access it would otherwise result in an HTTP 404 Page Not Found error. Recognizing that users of web browser software desiring to visit the web page of the San Diego Zoo will inadvertently type www.sandiegozoo.edu, the proprietor of the present invention operating information processor 202 registers www.sandiegozoo.edu and installs URL redirection programming code to redirect a user's browser that requests a session with www.sandiegozoo.edu to an alternative web site.

Continuing with the above example, a web site that specializes in coupons to the San Diego Zoo desires to have all traffic from www.sandiegozoo.edu to be redirected thereto. Another web site that specializes in children's merchandise relating to various animals similarly desires that web traffic. According to a preferred embodiment, each of the two web sites proprietors submits a bid to the proprietor of the present invention for the redirected traffic. The coupon provider bids more than the children's merchandise supplier and, accordingly, wins the redirected traffic.

In an alternative example, the user simply enters the keyword, “zoos,” into his web browser address bar. Typically, the user's browser will resolve the keyword “zoos” to www.zoos.com. The domain name, “zoos.com” is registered to a party to the present invention, and the user's internet session is redirected to the proprietor's information processor 202. Thereafter, the user is redirected to coupon provider's web site (in the above example).

In a preferred embodiment, the present invention includes a database that stores information related to each of the respective bids and web sites. Further, the database stores information related to web traffic from which the redirection process will originate. The database further stores bid amounts for the respective web sites. A matching process preferably occurs in which the highest bidder is identified from the database and traffic to a corresponding domain is redirected too.

Various other embodiments are envisioned herein that, as one skilled in the art will recognize, are within the scope of the present invention. In one embodiment, it is envisioned that predetermined periods of time, for example, monthly-periods, quarterly-periods or annual periods of time are measured for redirecting web traffic. Continuing with the above example regarding the San Diego Zoo web site, the proprietor of the coupons is entitled to the redirected traffic for a fixed period of time, such as, three months. In an alternative embodiment, the amount of time that the highest bidder wins is based upon the number of bidders in the process. For example, the amount of time for redirection that the highest bidder is entitled to is lower if many bidders compete for the redirected traffic as opposed to if relatively few bidders compete.

In yet another alternative, the amount of time the winning bidder receives the redirected traffic depends upon the amount of money charged by the proprietor of the present invention. In still a further embodiment, the proprietor of the present invention forms other rules regarding the amount of time a winning bidder is entitled to redirected web traffic. In still another embodiment, redirected web traffic may be divided among the bidders. For example, the price for the redirected traffic may be fixed at $3.00 per redirection. If five parties each pay the $3.00, then for every ten instances of redirection, each party receives two instances of the redirected traffic. One skilled in the art will recognize that many alternative models may be fashioned without departing from the spirit of the teachings herein.

In another alternative embodiment, it is envisioned that the present invention can work in conjunction with a search engine. For example, a user submits a keyword search in a search engine for zoos. The search engine displays a list of hyperlinks that represent results of the search. As known to one skilled in the art, occasionally the hyperlinks provided in a search result list in a search engine are obsolete. This can occur because certain domain names change, expire or the like. In accordance with one embodiment, the present invention preferably redirects traffic to a link that would otherwise be considered obsolete. For example, the San Diego Zoo has changed its domain from sandiegozoo.edu to sandiegozoo.org. A proprietor of the present invention recognizes that the domain has changed and promptly registers the domain name sandiegozoo.edu. Thereafter, a user in a search engine types San Diego Zoo in a text box to generate a keyword search. The search engine has not yet updated its own database and provides the otherwise broken link to sandiegozoo.edu.

Continuing with this example, as noted above, the present invention includes a bidding process in which, in the present example, proprietors of various web sites have bid for redirected traffic resulting from sandiegozoo.edu. Accordingly, when the user receives the search result list that includes the otherwise broken link to sandiegozoo.edu, his web browser software application is redirected to the highest bidder who seeks traffic originating from sandiegozoo.com. In this way, the present invention can be integrated in an existing search engine technology and enable proprietors of the present invention to generate revenue as a result. Further, the present invention recognizes that sales and other forms of revenue are likely for parties who receive redirected web site traffic, in accordance with the teachings herein.

Furthermore, as one skilled in the art recognizes, the present invention provides a business model by which revenue is generated by the parties who have redirected traffic from one or more web sites resulting of web traffic. A proprietor of the present invention can earn revenue for redirected traffic. Proprietors of web sites also financially benefit from the present invention, for example, from purchases made by users who are redirected to their respective sites. Further, such proprietors may offer specials, such as coupons to those who are redirected to the proprietors' sites, which provides benefits of users of web browsers that are redirected.

These and other benefits and business systems and methods are preferably included as features of the present invention.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for receiving payment by brokering communication network traffic, the method comprising:
registering a first domain;
receiving an offer of payment from a party in exchange for the party receiving redirected communication network traffic, wherein the traffic is generated from a request for a connection to a first resource associated with the first domain;
accepting the offer from the party for the redirected traffic;
receiving a request for a connection to the first resource; and
redirecting the traffic to a second resource in exchange for the payment.

2. The method of claim 1, further comprising receiving a second offer from an other party and comparing the two offers, wherein the step of accepting the offer is made as a function of the comparing.

3. The method of claim 1, wherein the second resource is associated with a second domain.

4. The method of claim 1, further comprising registering a third domain, wherein the traffic is generated from requests for a connection to a resource associated with either the first domain or the third domain.

5. The method of claim 1, further comprising registering a third domain, wherein the traffic is generated from requests for connections to resources associated with the first domain and the third domain.

6. The method of claim 1, wherein the first domain is registered to an other party, and further comprising paying a portion of the payment to the other party.

7. The method of claim 1, wherein the traffic is generated as a function of a hypertext transport protocol error.

8. The method of claim 7, wherein the error is Page Not Found, Bad Request or Unauthorized.

9. The method of claim 1, wherein the traffic is redirected to a computing device before the traffic is redirected to a second domain name.

10. The method of claim 9, wherein the traffic is redirected to the computing device by an internet service provider, a DNS server, a proxy server, a router or a firewall.

11. The method of claim 1, further comprising:
receiving a second offer from an other party;
accepting the first offer and the second offer; and
alternating redirecting the traffic between the second domain and a third domain in exchange for payment corresponding to the fist offer and the second offer.

12. The method of claim 1, wherein the party that registered the first domain receives the payment.

13. The method of claim 1, wherein the offer specifies receiving redirected traffic generated for fixed number of requests for connections to the first resource.

14. The method of claim 1, wherein the offer specifies receiving redirected traffic generated for requests for connections to the first resource received over a fixed amount of time.

15. A system for receiving payment by brokering communication network traffic, the system comprising:
a domain registered to a first party;
an offer of payment provided from a second party in exchange for the second party receiving redirected communication network traffic, wherein the traffic is generated from a request for a connection to a first resource associated with the first domain;
an acceptance of the offer for the redirected traffic;
a request received for a connection to the first resource; and
a redirection module that redirects the traffic to a second resource in exchange for the payment.

16. The system of claim 15, wherein the second resource is associated with a second domain.

17. The system of claim 15, further comprising a third domain registered to a third party, wherein the traffic is generated from requests for connections to resources associated with either the first domain or the third domain.

18. The system of claim 15, further comprising a third domain registered to a third party, wherein the traffic is generated from requests for connections to resources associated with both the first domain and the third domain.

19. The system of claim 15, wherein the traffic is redirected to a computing device before the traffic is redirected to a second domain name.

20. A system for redirecting an internet web browser, the application comprising:
a first module operable to determine an hypertext transport protocol error received in connection with a request from the web browser to access a first resource;
a second module operable to determine an identification of the web browser making the request;
a third module operable to receive a plurality of bids for receiving the redirected web browser, wherein each of the bids are stored on an information processor;
a fourth module operable to communicate with the information processor to determine the highest of the plurality of bids and to determine a web site associated with the highest bid; and
a fifth module operable to redirect the web browser to the web site associated with the highest bid.
